(19) United States
(12) Patent Application Publication
(10) Pub. No.: US 2017/0002701 A1
(43) Pub. Date: Jan. 5, 2017

(54) VALVE TIMING CONTROL DEVICE FOR INTERNAL COMBUSTION ENGINE

(71) Applicant: HITACHI AUTOMOTIVE SYSTEMS, LTD., Hitachinaka-shi (JP)

(72) Inventor: Mikihiro KAJIURA, Tama-shi, Tokyo (JP)

(73) Assignee: HITACHI AUTOMOTIVE SYSTEMS, LTD., Hitachinaka-shi, Ibaraki (JP)

(21) Appl. No.: 15/039,905

(22) PCT Filed: Nov. 11, 2014
(86) PCT No.: PCT/JP2014/079799

§ 371 Date: May 27, 2016

(30) Foreign Application Priority Data
Dec. 11, 2013 (JP) 2013-255529

(51) Int. Cl. F01L 1/356; H02K 7/00; H02K 13/10; H02K 13/00; H02K 5/04

(52) U.S. Cl. CPC F01L 1/356; H02K 13/003; H02K 5/04; H02K 13/10; H02K 7/006

(57) ABSTRACT

A valve timing control device for an internal combustion engine is provided which is devised to shorten an axial length of a brush retaining portion of a retaining member and thereby reduce in size whole of the device.

The retaining member 28 attached to a cover member includes a power-feeding brush 30a, 30b in a brush guide portion 29a, 29b of the brush retaining portion 28a. The power-feeding brush is slidable and in contact with a slip ring 26a, 26b provided to an electric motor. A concave-groove-shaped spring receiving chamber 41 is provided lateral to the brush guide portion such that the spring receiving chamber is in parallel with the power-feeding brush. A torsion coil spring 42 that biases the power-feeding brush toward the slip ring via its another end portion 42c is provided in the spring receiving chamber.

### TECHNICAL FIELD

The present invention relates to a valve timing control device for an internal combustion engine, which controls opening and closing timings of an intake valve and/or an exhaust valve.

### BACKGROUND ART

Recently, a valve timing control device is proposed in which opening and closing timings of intake or exhaust valve are controlled by transmitting rotational force of an electric motor through a speed-reduction mechanism to a cam shaft and thereby varying a relative rotational phase of the cam shaft to a sprocket to which rotational force is transmitted from a crankshaft.

For example, in the valve timing control device disclosed in Patent literature 1, electric current supplied through a pigtail harness from a battery is supplied to the electric motor by way of power-feeding brush and slip ring only when varying a valve timing, in order to reduce power consumption as much as possible.

### CITATION LIST

### Patent Literature

Patent Literature 1: Japanese Patent Application Publication No. 2012-132367

### SUMMARY OF THE INVENTION

### Problem to be Solved

However, in the case of valve timing control device disclosed in Patent Literature 1, the power-feeding brush is elastically in contact with the slip ring in an axial direction. Hence, a coil spring is arranged in series with the power-feeding brush with respect to the axial direction, on a rear end side of the power-feeding brush. Therefore, a length of a retaining member for retaining the power-feeding brush and the coil spring, which is measured along the axial direction of the cam shaft, i.e. a length in a width direction thereof is inevitably long. Hence, whole of the valve timing control device inevitably grows in size in the axial direction. As a result, there is a risk that an internal combustion engine equipped with the valve timing control device has a limited mountability to an accommodation space of engine room.

It is an object of the present invention to provide a valve timing control device for an internal combustion engine, devised to shorten the axial length of a brush retaining portion of the retaining member and thereby reduce in size whole of the device.

### Solution to Problem

A device recited in claim 1 according to the present invention comprises: a drive rotating member configured to receive rotational force from a crankshaft; a driven rotating member fixed to a cam shaft configured to receive rotational force from the drive rotating member; an electric motor including the motor housing configured to rotate together with the drive rotating member or the driven rotating member, the electric motor being configured to rotate the drive rotating member relative to the driven rotating member by a suppled electric current; a power-feeding brush provided outside of the electric motor and configured to supply electric power to the electric motor; a slip ring provided on another of the rotating member and the fixed member and configured to slide in contact with the power-feeding brush; and a torsion coil spring biasing the power-feeding brush toward the slip ring, wherein the torsion coil spring is arranged lateral to the power-feeding brush such that the torsion coil spring is in parallel with the power-feeding brush.

### Effects of Invention

Accordingly, the axial length of whole the valve timing control device can be shortened as far as possible, so that the device can be downsized.

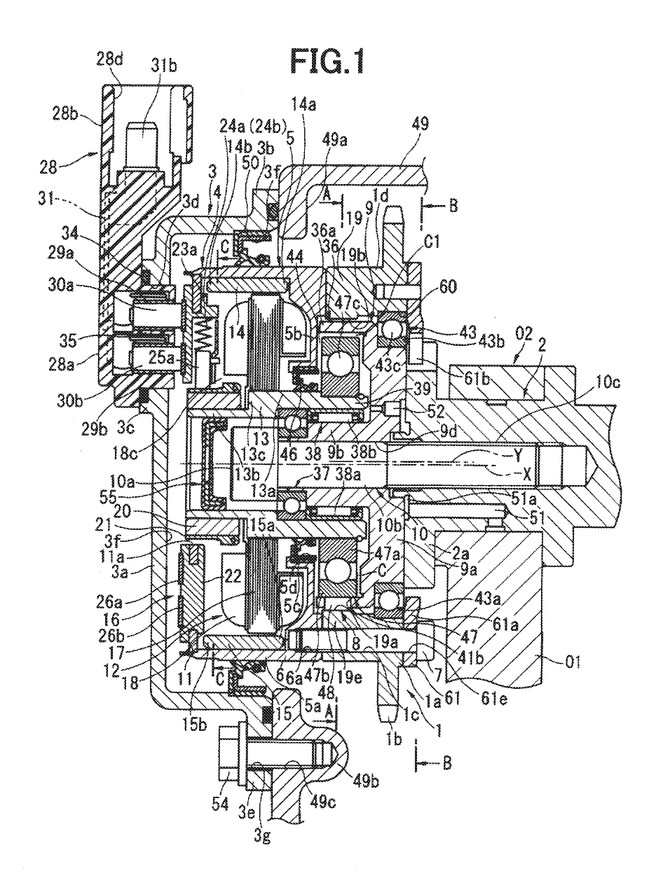

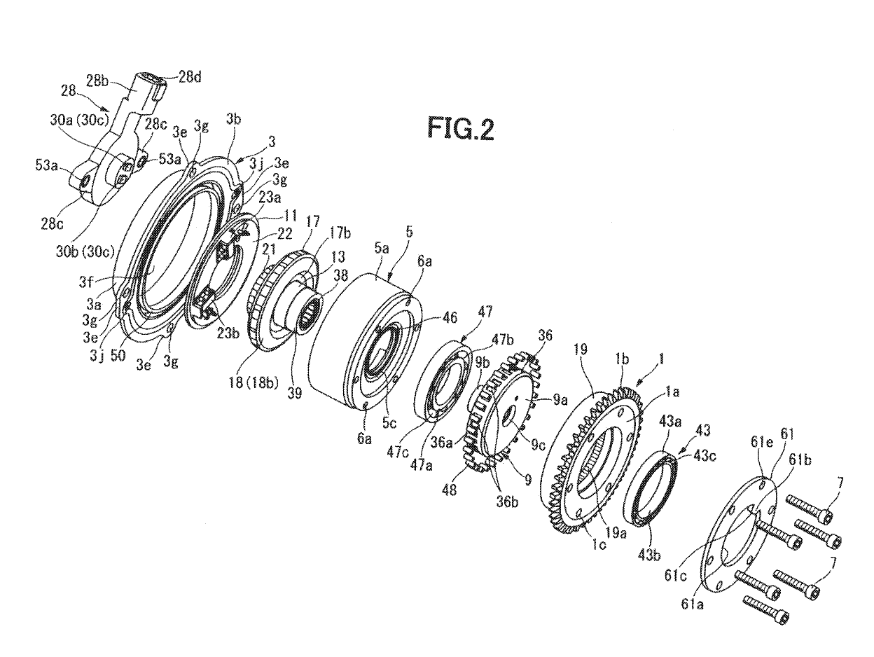

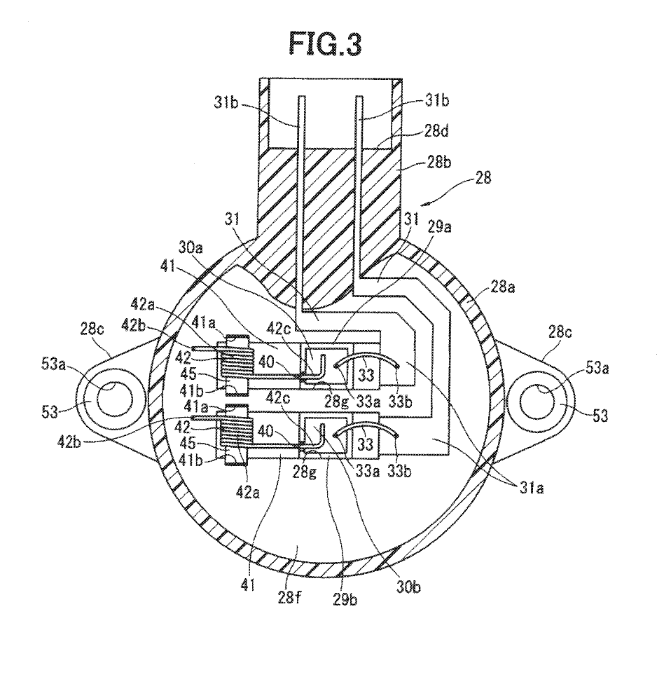

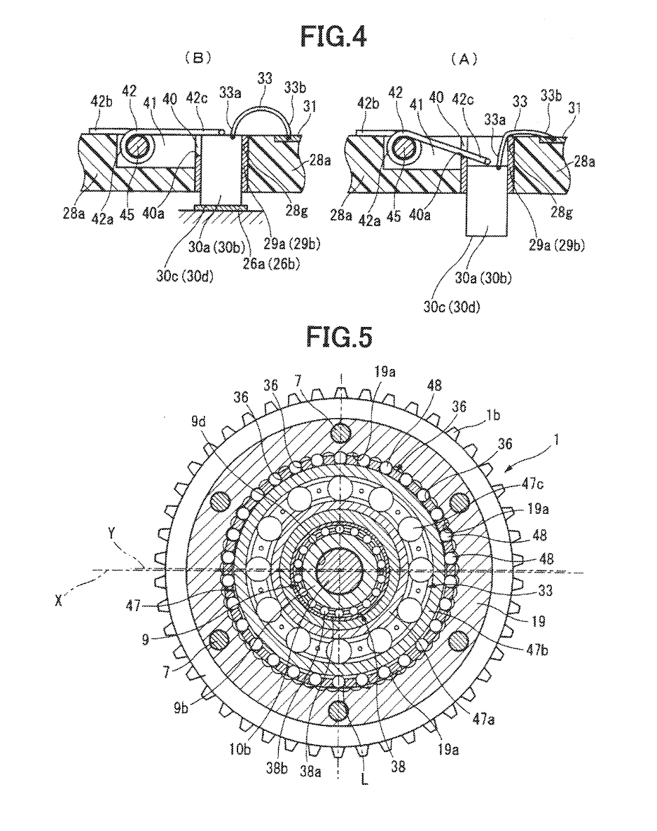

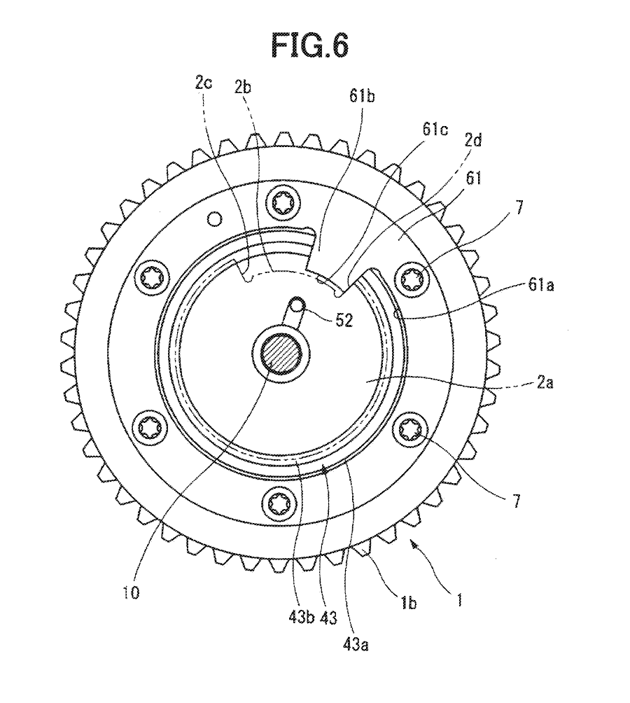

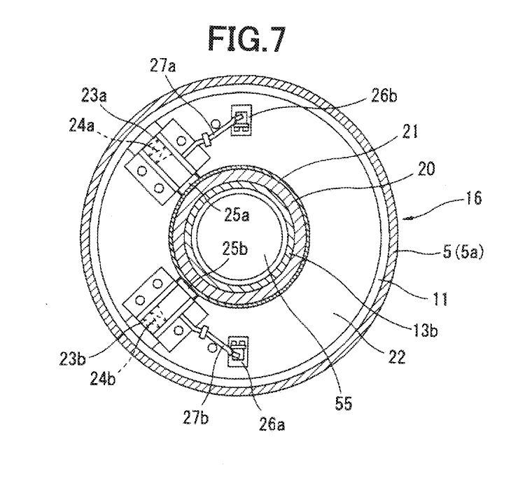

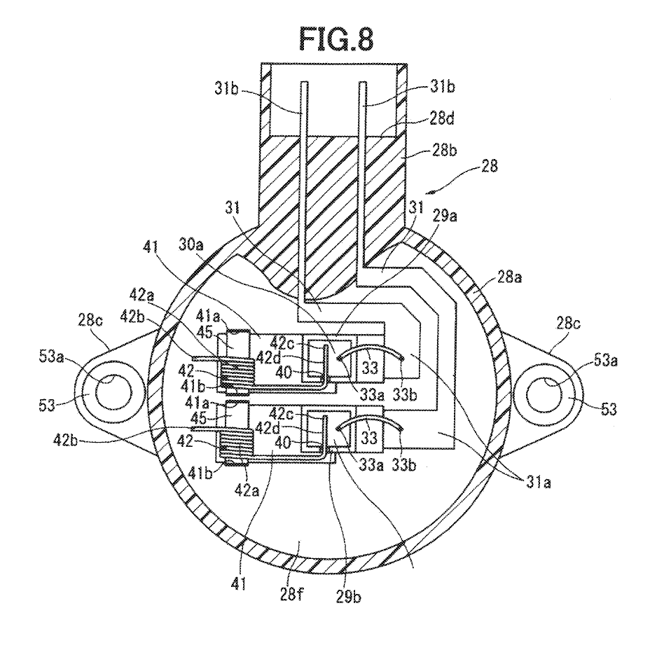

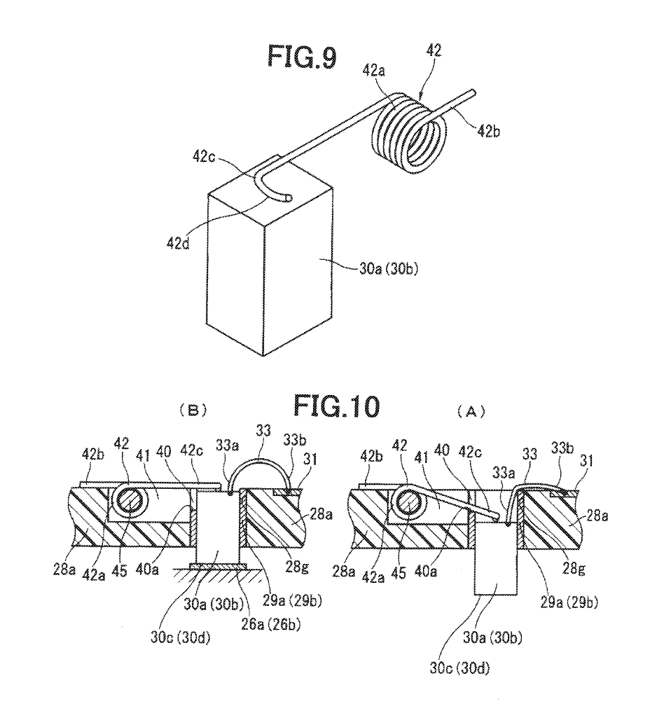

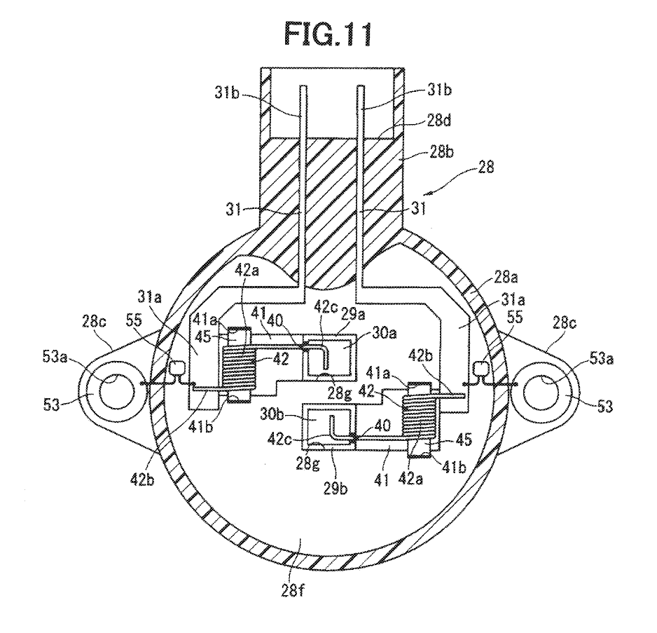

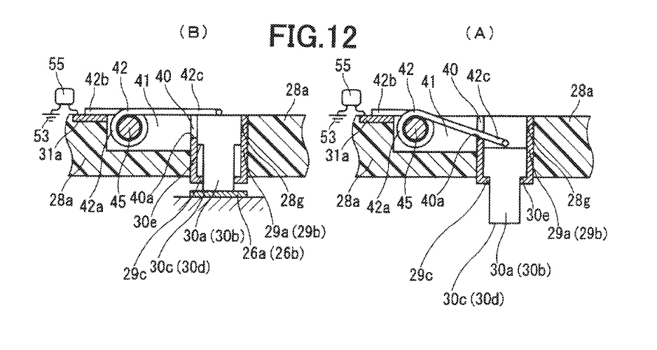

### BRIEF EXPLANATION OF DRAWINGS

[FIG. 1] A longitudinal sectional view illustrating a first embodiment of a valve timing control device according to the present invention.

[FIG. 2] An exploded perspective view illustrating main structural elements in the first embodiment.

[FIG. 3] A transverse sectional view of a retaining member provided in the first embodiment.

[FIG. 4] Sectional views of main structural elements provided in the first embodiment. FIG. 4A illustrates a state where the retaining member has not yet been attached to a cover member. FIG. 4B illustrates a state where the retaining member has already been attached to the cover member.

[FIG. 5] A sectional view of FIG. 1, taken along a line A-A.

[FIG. 6] A sectional view of FIG. 1, taken along a line B-B.

[FIG. 7] A sectional view of FIG. 1, taken along a line C-C.

[FIG. 8] A transverse sectional view of a retaining member provided in a second embodiment according to the present invention.

[FIG. 9] An oblique perspective view illustrating a state where another end portion of a torsion coil spring is in contact with a power-feeding brush provided in the second embodiment.

[FIG. 10] Sectional views of main structural elements provided in the second embodiment. FIG. 10A illustrates a state where the retaining member has not yet been attached to a cover member. FIG. 10B illustrates a state where the retaining member has already been attached to the cover member.

[FIG. 11] A transverse sectional view of a retaining member provided in a third embodiment according to the present invention.

[FIG. 12] Sectional views of main structural elements provided in the third embodiment. FIG. 12A illustrates a state where the retaining member has not yet been attached to a cover member. FIG. 12B illustrates a state where the retaining member has already been attached to the cover member.

### DETAILED DESCRIPTION OF INVENTION

Hereinafter, an embodiment of a valve timing control device for an internal combustion engine according to the present invention will be explained referring to the drawings. In this embodiment, the valve timing control device is applied to an intake-valve side of the internal combustion engine.

As shown in FIGS. 1 and 2, the valve timing control device includes a timing sprocket 1, a cam shaft 2, a cover member 3 and a phase change mechanism 4. The timing sprocket 1 (functioning as a drive rotating member) is rotated and driven by a crankshaft of the internal combustion engine. The cam shaft 2 is rotatably supported on a cylinder head 01 through a bearing 02, and is rotated by a rotational force transmitted from the timing sprocket 1. The cover member 3 is provided on a front side (in an axially frontward direction) of the timing sprocket 1, and is fixedly attached to a chain cover 49. The phase change mechanism 4 is provided between the timing sprocket 1 and the cam shaft 2, and is configured to change a relative rotational phase between the timing sprocket 1 and the cam shaft 2 in accordance with an operating state of the engine.

Whole of the timing sprocket 1 is integrally formed of an iron-based metal in an annular shape. The timing sprocket 1 includes a sprocket main body 1a, a gear portion 1b and an internal-teeth constituting portion (internal-gear portion) 19. An inner circumferential surface of the sprocket main body 1a is formed in a stepped shape to have two relatively large and small diameters as shown in FIG. 1. The gear portion 1b is formed integrally with an outer circumference of the sprocket main body 1a, and receives rotational force through a wound timing chain (not shown) from the crankshaft. The internal-teeth constituting portion 19 is formed integrally with a front end portion of the sprocket main body 1a.

A large-diameter ball bearing 43 which is a bearing having a relatively large diameter is interposed between the sprocket main body 1a and an after-mentioned follower member 9 provided on a front end portion of the cam shaft 2. The timing sprocket 1 is rotatably supported by the cam shaft 2 through the large-diameter ball bearing 43 such that a relative rotation between the cam shaft 2 and the timing sprocket 1 is possible.

The large-diameter ball bearing 43 includes an outer race 43a, an inner race 43b, and a ball(s) 43c interposed between the outer race 43a and the inner race 43b. The outer race 43a of the large-diameter ball bearing 43 is fixed to an inner circumferential portion of the sprocket main body 1a whereas the inner race 43b of the large-diameter ball bearing 43 is fixed to an outer circumferential portion of the follower member 9.

The inner circumferential portion of the sprocket main body 1a is formed with an outer-race fixing portion 60 which is in an annular-groove shape as obtained by cutting out a part of the inner circumferential portion of the sprocket main body 1a. The outer-race fixing portion 60 is formed to be open toward the cam shaft 2.

The outer-race fixing portion 60 is formed in a stepped shape to have two relatively large and small diameters. The outer race 43a of the large-diameter ball bearing 43 is fitted into the outer-race fixing portion 60 by press fitting in an axial direction of the timing sprocket 1. Thereby, one axial end of the outer race 43a is placed at a predetermined position, that is, a positioning of the outer race 43a is performed.

The internal-teeth constituting portion 19 is formed integrally with an outer circumferential side of the front end portion of the sprocket main body 1a. The internal-teeth constituting portion 19 is formed in a cylindrical shape (circular-tube shape) extending in a frontward direction of the phase change mechanism 4. An inner circumference of the internal-teeth constituting portion 19 is formed with internal teeth (internal gear) 19a which have a wave shape.

Moreover, a female-thread constituting portion 6 formed integrally with an after-mentioned motor housing 5 is placed to face a front end portion of the internal-teeth constituting portion 19. The female-thread constituting portion 6 is formed in an annular shape.

Moreover, an annular retaining plate 61 is disposed on a rear end portion of the sprocket main body 1a, on the side opposite to the internal-teeth constituting portion 19. This retaining plate 61 is integrally formed of metallic sheet material. As shown in FIG. 1, an outer diameter of the retaining plate 61 is approximately equal to an outer diameter of the sprocket main body 1a. An inner diameter of the retaining plate 61 is smaller than an inner diameter of the outer race 43a of the large-diameter ball bearing 43.

An inner circumferential portion 61a of the retaining plate 61 is in contact with an axially outer end surface of the outer race 43a. Moreover, a stopper convex portion 61b which protrudes in a radially-inner direction of the annular retaining plate 61, i.e. protrudes toward a central axis of the annular retaining plate 61 is provided at a predetermined location of an inner circumferential edge (i.e., radially-inner edge) of the inner circumferential portion 61a. This stopper convex portion 61b is formed integrally with the inner circumferential portion 61a.

As shown in FIGS. 1 and 6, the stopper convex portion 61b is formed in a substantially fan shape. A tip edge 61c of the stopper convex portion 61b is formed in a circular-arc shape in cross section, along a circular-arc-shaped inner circumferential surface of an after-mentioned stopper groove 2b. Moreover, an outer circumferential portion of the retaining plate 61 is formed with six bolt insertion holes 61d each of which passes through the retaining plate 61. The six bolt insertion holes 61d are formed at circumferentially equally-spaced intervals in the outer circumferential portion of the retaining plate 61. A bolt 7 is inserted through each of the six bolt insertion holes 61d.

An outer circumferential portion of the sprocket main body 1a (the internal-teeth constituting portion 19) is formed with six bolt insertion holes 1c each of which axially passes through the timing sprocket 1a. The six bolt insertion holes 1c are formed substantially at circumferentially equally-spaced intervals in the outer circumferential portion of the sprocket main body 1a. Moreover, the female-thread constituting portion 6 is formed with six female threaded holes 6a at its portions respectively corresponding to the six bolt insertion holes 1c and the six bolt insertion holes 61d. By the six bolts 7 inserted into the six bolt insertion holes 61d, the six bolt insertion holes 1c and the six female threaded holes 6a; the timing sprocket 1a, the retaining plate 61 and the motor housing 5 are jointly fastened to one another from the axial direction.

It is noted that the sprocket main body 1a and the internal-teeth constituting portion 19 function as a casing for an after-mentioned speed-reduction mechanism 8.

The timing sprocket 1a, the internal-teeth constituting portion 19, the retaining plate 61 and the female-thread constituting portion 6 have outer diameters substantially equal to one another.

As shown in FIG. 1, the chain cover 49 is fixed to a front end portion of a cylinder block (not shown) and the cylinder head 01 which constitute a main body of the engine. The chain cover 49 is disposed along an upper-lower direction to cover a chain (not shown) wound around the timing sprocket 1a. The chain cover 49 is formed with an opening portion at a location corresponding to the phase change mechanism 4. An annular wall 49a constituting the opening portion of the chain cover 49 is formed with four boss portions 49b. The four boss portions 49b are formed integrally with the annular wall 49a and are located at circumferential four spots of the annular wall 49a. A female threaded hole 49c is formed in the annular wall 49a and each boss portion 49b to pass through the annular wall 49a and reach an interior of the each boss portion 49b. That is, four female threaded holes 49c corresponding to the four boss portions 49b are formed.

As shown in FIGS. 1 and 2, the cover member 3 is made of aluminum alloy material and is integrally formed in a cup shape. The cover member 3 is provided to face and cover a front end portion of the motor housing 5. The cover member 3 includes a cover main body 3a and a mounting flange 3b. The cover main body 3a bulges out in the cup shape (protrudes in an expanded state) frontward in the axial direction. The mounting flange 3b is in an annular shape (ring shape) and is formed integrally with an outer circumferential edge of an opening-side portion of the cover main body 3a. Moreover, an outer circumferential portion of the cover main body 3a is formed with a cylindrical wall 3c shortly extending in the axial direction. That is, the cylindrical wall 3c is formed integrally with the cover main body 3a and includes a retaining hole 3d therein.

The mounting flange 3b includes four boss portions 3e. The four boss portions 3e are formed substantially at circumferentially equally-spaced intervals (approximately at every 90-degree location) on the mounting flange 3b. As shown in FIG. 1, each boss portion 3e is formed with a bolt insertion hole 3g. The bolt insertion hole 3g passes through the boss portion 3e. Each bolt 54 is inserted through the bolt insertion hole 3g and is screwed in the female threaded hole 49d formed in the chain cover 49. By these bolts 54, the cover member 3 is fixed to the chain cover 49.

An oil seal 50 which has a large diameter is interposed between an outer circumferential surface of the motor housing 5 and an inner circumferential surface of a stepped portion (multilevel portion) of outer circumferential side of the cover main body 3a. The large-diameter oil seal 50 is formed in a substantially U-shape in cross section. A core metal is buried inside a base material formed of synthetic rubber. An annular base portion of outer circumferential side of the large-diameter oil seal 50 is fixedly fitted in a stepped annular portion 3h formed in the inner circumferential surface of the cover member 3.

As shown in FIG. 1, the motor housing 5 includes a housing main body 5a and a sealing plate 11. The housing main body 5a is formed in a tubular shape having its bottom by press molding. The housing main body 5a is formed of iron-based metal. The sealing plate 11 is formed of non-magnetic synthetic resin, and seals a front-end opening of the housing main body 5a.

The housing main body 5a includes a dividing wall 5b at a rear end portion of the housing main body 5a. The dividing wall 5b is formed in a circular-disk shape. Moreover, the dividing wall 5b is formed with a shaft insertion hole 5c having a large diameter, at a substantially center of the dividing wall 5b. An after-mentioned eccentric shaft portion 39 is inserted through the shaft insertion hole 5c. A hole edge of the shaft insertion hole 5c is formed integrally with an extending portion (exiting portion) 5d which protrudes from the dividing wall 5b in the axial direction of the cam shaft 2 in a cylindrical-tube shape. Moreover, an outer circumferential portion of a front-end surface of the dividing wall 5b is formed integrally with the female-thread constituting portion 6.

The cam shaft 2 includes two drive cams per one cylinder of the engine. Each drive cam is provided on an outer circumference of the cam shaft 2, and functions to open an intake valve (not shown). The front end portion of the cam shaft 2 is formed integrally with a flange portion 2a.

As shown in FIG. 1, an outer diameter of the flange portion 2a is designed to be slightly larger than an outer diameter of an after-mentioned fixing end portion 9a of the follower member 9. An outer circumferential portion of a front end surface of the flange portion 2a is in contact with an axially outer end surface of the inner race 43b of the large-diameter ball bearing 43, after an assembly of respective structural components. Moreover, the front end surface of the flange portion 2a is fixedly connected with the follower member 9 from the axial direction by a cam bolt 10 under a state where the front end surface of the flange portion 2a is in contact with the follower member 9 in the axial direction.

As shown in FIG. 6, an outer circumference of the flange portion 2a is formed with a stopper concave groove 2b into which the stopper convex portion 61b of the retaining plate 61 is inserted and engaged. The stopper concave groove 2b is formed along a circumferential direction of the flange portion 2a. (A bottom surface of) The stopper concave groove 2b is formed in a circular-arc shape in cross section. The stopper concave groove 2b is formed in an outer circumferential surface of the flange portion 2a within a predetermined range given in a circumferential direction of the cam shaft 2. The cam shaft 2 rotates within this circumferential range relative to the sprocket main body 1a so that one of both end edges of the stopper convex portion 61b becomes in contact with the corresponding one of circumferentially-opposed edges 2c and 2d of the stopper concave groove 2b. Thereby, a relative rotational position of the cam shaft 2 to the timing sprocket 1 is restricted between a maximum advanced side and a maximum retarded side.

The stopper convex portion 61b is disposed axially away toward the cam shaft 2 from a point at which the outer race 43a of the large-diameter ball bearing 43 is pressed by the spacer 62 for fixing the outer race 43a in the axial direction. Accordingly, the stopper convex portion 61b is not in contact with the fixing end portion 9a of the follower member 9 in the axial direction. Therefore, an interference between the stopper convex portion 61b and the fixing end portion 9a can be sufficiently suppressed.

As shown in FIG. 1, the cam bolt 10 includes a head portion 10a and a shaft portion 10b. An end surface of the head portion 10a which is located on the side of the shaft portion 10b supports an inner race of a small-diameter ball bearing 37 in the radial direction of the cam bolt 10. An outer circumference of the shaft portion 10b includes a male thread portion 10c which is screwed into a female threaded portion of the cam shaft 2. The female threaded portion of the cam shaft 2 is formed from the end portion of the cam shaft 2 toward an inside of the cam shaft 2 in the axial direction.

The follower member 9 which functions as a driven rotating member is integrally formed of an iron-based metal. As shown in FIG. 1, the follower member 9 includes the fixing end portion 9a, a cylindrical portion (circular tube portion) 9b and a cylindrical retainer 36. The fixing end portion 9a is in a circular-plate shape and is formed in a rear end side (a cam-shaft-side portion) of the follower member 9. The cylindrical portion 9b protrudes in the axial direction from a front end of an inner circumferential portion of the fixing end portion 9a. The retainer 36 is formed integrally with an outer circumferential portion of the fixing end portion 9a, and retains or guides a plurality of rollers 48.

A rear end surface of the fixing end portion 9a is in contact with the front end surface of the flange portion 2a of the cam shaft 2. The fixing end portion 9a is pressed and fixed to the flange portion 2a in the axial direction by an axial force of the cam bolt 10.

As shown in FIG. 1, the cylindrical portion 9b is formed with an insertion hole 9d passing through a center of the cylindrical portion 9b in the axial direction. The shaft portion 10b of the cam bolt 10 is passed through the insertion hole 9d. Moreover, a needle bearing 38 functions as a bearing member is provided on an outer circumferential side of the cylindrical portion 9b.

As shown in FIG. 1, the retainer 36 is formed in a cylindrical shape (circular-tube shape) having its bottom and protruding from the bottom in the extending direction of the cylindrical portion 9b. The retainer 36 is forwardly bent in a substantially L-shape in cross section from a front end of the outer circumferential portion of the fixing end portion 9a.

A tubular tip portion 36a of the retainer 36 extends and exits through an accommodating space 44 toward the dividing wall 5b of the motor housing 5. The accommodating space 44 is formed in an annular concave shape between the female-thread constituting portion 6 and the extending portion 5d. Moreover, as shown in FIGS. 1 and 2, a plurality of roller-retaining holes 36b are formed in the tubular tip portion 36a substantially at circumferentially equally-spaced intervals. Each of the to plurality of roller-retaining holes 36b is formed in a substantially rectangular shape in cross section, and retains the roller 48 to allow a rolling movement of the roller 48. The total number of the roller-retaining holes 36b (or the total number of the rollers 48) is smaller by one than the total number of the internal teeth 19a of the internal-teeth constituting portion 19.

The phase change mechanism 4 mainly includes an electric motor 12 and the speed-reduction mechanism 8. The electric motor 12 is disposed on a front end side of the cylindrical portion 9b of the follower member 9. The speed-reduction mechanism 8 functions to reduce a rotational speed of the electric motor 12 and to transmit the reduced rotational speed to the cam shaft 2.

As shown in FIGS. 1 and 2, the electric motor 12 is a brush DC motor. The electric motor 12 is constituted by the motor housing 5, a motor output shaft 13, a pair of permanent magnets 14 and 15, and a stator 16. The motor housing 5 is a yoke which rotates integrally with the timing sprocket 1. The motor output shaft 13 is arranged inside the motor housing 5 to be rotatable relative to the motor housing 5. The pair of permanent magnets 14 and 15 are fixed to an inner circumferential surface of the motor housing 5. Each of the pair of permanent magnets 14 and 15 is formed in a half-round arc shape. The stator 16 is fixed to the sealing plate 11.

The motor output shaft 13 is formed in a stepped tubular shape (in a cylindrical shape having multileveled surface), and functions as an armature. The motor output shaft 13 includes a large-diameter portion 13a, a small-diameter portion 13b, and a stepped portion (multilevel-linking portion) 13c. The stepped portion 13c is formed at a substantially axially center portion of the motor output shaft 13, and is a boundary between the large-diameter portion 13a and the small-diameter portion 13b. The large-diameter portion 13a is located on the side of the cam shaft 2 whereas the small-diameter portion 13b is located on the side opposite to the cam shaft 2 with respect to the stepped portion 13c. An iron-core rotor 17 is fixed to an outer circumference of the large-diameter portion 13a. The eccentric shaft portion 39 constituting a part of the speed-reduction mechanism 8 is formed integrally with a rear end portion of the large-diameter portion 13a.

On the other hand, an annular member (tubular member) 20 is fitted over and fixed to an outer circumference of the small-diameter portion 13b by press fitting. A commutator 21 is fitted over and fixed to an outer circumferential surface of the annular member 20 by means of press fitting in the axial direction. Hence, an outer surface of the stepped portion 13c performs an axial positioning of the annular member 20 and the commutator 21. An outer diameter of the annular member 20 is substantially equal to an outer diameter of the large-diameter portion 13a. An axial length of the annular member 20 is slightly shorter than an axial length of the small-diameter portion 13b.

Lubricating oil is supplied to an inside space of the motor output shaft 13 and the eccentric shaft portion 39 in order to lubricate the bearings 37 and 38. A plug member 55 is fixedly fitted into an inner circumferential surface of the small-diameter portion 13b by press fitting. The plug member 55 inhibits the lubricating oil from leaking to the external.

The iron-core rotor 17 is formed of magnetic material having a plurality of magnetic poles. An outer circumferential side of the iron-core rotor 17 constitutes bobbins each having a slot. (A coil wire of) A coil 18 is wound on the bobbin.

The commutator 21 is made of electrical conductive material and is formed in an annular shape. The commutator 21 is divided into segments. The number of the segments is equal to the number of poles of the iron-core rotor 17. Each of the segments of the commutator 21 is electrically connected to an end portion of the coil wire of the coil 18.

The permanent magnets 14 and 15 are formed in a cylindrical shape (circular-tube shape), as a whole. The permanent magnets 14 and 15 have a plurality of magnetic poles along a circumferential direction thereof. An axial location of the permanent magnets 14 and 15 is deviated (offset) toward the stator 16 from a center of the iron-core rotor 17, with respect to the axial direction. Thereby, a front end portion of the permanent magnet 14, 15 overlaps with the commutator 21 and also an after-mentioned switching brush 25a, 25b of the stator 16 and so on, in the radial direction.

As shown in FIG. 7, the stator 16 mainly includes a resin plate 22, a pair of resin holders 23a and 23b, a pair of switching brushes 25a and 25b each functioning as a switching brush (commutator), inner and outer slip rings 26a and 26b, and harnesses 27a and 27b. The resin plate 22 is formed in a circular plate shape, and is formed integrally with an inner circumferential portion of the sealing plate 11. The pair of resin holders 23a and 23b are provided on an inside portion of the resin plate 22. The pair of switching brushes 25a and 25b are received or accommodated respectively in the pair of resin holders 23a and 23b such that the switching brushes 25a and 25b are able to slide in contact with the resin holders 23a and 23b in the radial direction. Thereby, a tip surface of each of the switching brushes 25a and 25b is elastically in contact with an outer circumferential surface of the commutator 21 in the radial direction by a spring force of coil spring 24a, 24b. Each of the inner and outer power-feeding slip rings 26a and 26b is formed in an annular shape. The inner and outer power-feeding slip rings 26a and 26b are buried in and fixed to front end surfaces of the resin holders 23a and 23b under a state where outer end surfaces of the power-feeding slip rings 26a and 26b are exposed to a space. The inner and outer power-feeding slip rings 26a and 26b are disposed at radially inner and outer locations in a manner of radially-double layout. The harness 27a electrically connects the switching brush 25a with the slip ring 26b whereas the harness 27b electrically connects the switching brush 25b with the power-feeding slip ring 26a.

A positioning of the sealing plate 11 is given by a concave stepped portion formed in an inner circumference of the front end portion of the motor housing 5. The sealing plate 11 is fixed into the concave stepped portion of the motor housing 5 by caulking. A shaft insertion hole 11a is formed in the sealing plate 11 to pass through a center portion of the sealing plate 11 in the axial direction. One end portion of the motor output shaft 13 and so on are passing through the shaft insertion hole 11a.

The retaining member 28 is fixed to the cover main body 3a. The retaining member 28 is integrally molded by synthetic resin material. As shown in FIGS. 1 to 4, the retaining member 28 is substantially formed in an L-shape as viewed laterally, i.e., in cross section. The retaining member 28 mainly includes a brush retaining portion 28a, a connector portion 28b, a pair of (right and left) boss portions 28c, and a pair of power-feeding terminal strips 31 and 31. The brush retaining portion 28a is substantially in a cylindrical shape having its bottom, and is inserted in the retaining hole 3d. The connector portion 28b is located opposite to the brush retaining portion 28a. Each boss portion 28c is formed integrally with the brush retaining portion 28a, and protrudes from one side surface of the brush retaining portion 28a. Through the boss portions 28c, the retaining member 28 is fixed to the cover main body 3a by bolts. A part of the pair of power-feeding terminal strips 31 and 31 is buried in the retaining member 28.

The brush retaining portion 28a is provided to extend in a substantially horizontal direction (i.e., in the axial direction). As shown in FIGS. 1 and 3, the brush retaining portion 28a is formed with a pair of fixing holes 28g and 28g each formed in a square-column shape, at upper and lower portions of an inside of the brush retaining portion 28a (i.e., at radially outer and inner portions with respect to an axis of the motor housing 5). The pair of fixing holes 28g and 28g extend in the axial direction of the cam shaft 2 and extend parallel to each other. A pair of brush guide portions 29a and 29b each having a square-tube shape are provided respectively in the fixing holes 28g and 28g of the brush retaining portion 28a, and are respectively fixed to the fixing holes 28g and 28g by press fitting. Power-feeding brushes 30a and 30b are guided respectively in the brush guide portions 29a and 29b to allow the power-feeding brushes 30a and 30b to slide in contact with the brush guide portions 29a and 29b in the axial direction.

As shown in FIG. 1, a partition wall 35 which separates (partitions off) the fixing holes 28g and 28g from each other is provided in the brush retaining portion 28a. The partition wall 35 is formed integrally with the brush retaining portion 28a.

Each of the brush guide portions 29a and 29b includes opening portions at front and rear ends of the brush guide portion 29a, 29b. A tip portion of each of the power-feeding brushes 30a and 30b is held by the brush guide portion 29a, 29b to be movable forwardly and backwardly from the front-end opening portion of the brush guide portion 29a, 29b. One end portion 33a of each of after-mentioned pigtail harnesses 33 and 33 is connected with a rear end of the power-feeding brush 30a, 30b by soldering, through the rear-end opening portion of the brush guide portion 29a, 29b. Moreover, each of the brush guide portions 29a and 29b is formed with an insertion groove (engagement groove) 40. The insertion groove 40 of each of the brush guide portions 29a and 29b is formed in a long-and-narrow slit shape such that the insertion groove 40 extends from a hole edge of the rear-end opening portion of the brush guide portion 29a, 29b in the axial direction. This insertion groove 40 is formed to have a substantially half length of the brush guide portion 29a, 29b with respect to the axial direction.

Each of the power-feeding brushes 30a and 30b is formed in a square-column shape, and has a predetermined axial length. A tip surface 30c, 30d of each of the power-feeding brushes 30a and 30b is in contact with the power-feeding slip ring 26a, 26b in the axial direction.

Moreover, the brush retaining portion 28a is formed with spring receiving chambers 41 and 41 which are located respectively lateral to the fixing holes 28g and 28g of the brush retaining portion 28, i.e. are located next to the fixing holes 28g and 28g in the horizontal direction shown in FIG. 3. Each of the spring receiving chambers 41 and 41 is formed in a concave groove shape. A torsion coil spring (helical torsion spring) 42 is disposed and accommodated in each of the spring receiving chambers 41 and 41.

As shown in FIGS. 3, 4A and 4B, each of the spring receiving chambers 41 and 41 is located adjacent to a sidewall of the brush guide portion 29a, 29b, at which the insertion groove 40 is formed. Each of the spring receiving chambers 41 and 41 is in a substantially rectangular shape as a planer view. The spring receiving chambers 41 and 41 are provided to be laterally continuous with the fixing holes 28g and 28g and to be in parallel with the fixing holes 28g and 28g.

Each of the torsion coil springs 42 and 42 is supported by a support shaft 45 in the spring receiving chamber 41. The support shaft 45 is provided to pass through a center portion 42a of each of the torsion coil springs 42 and 42. This center portion 42a is a coil-shaped wound portion of the torsion coil spring 42. U-shaped grooves 41a and 41b are formed in opposed inner surfaces of the spring receiving chamber 41. In a state where the support shaft 45 has been inserted into the center portion 42a of the torsion coil spring 42 in advance, axial both end portions of the support shaft 45 are fitted into the U-shaped grooves 41a and 41b down to a maximum downward location given by bottom portions of the U-shaped grooves 41a and 41b. Thus, each of the torsion coil spring 42 and 42 is positioned and received in the spring receiving chamber 41.

A liner-shaped one end portion 42b of each torsion coil spring 42 is elastically held by an upper surface of a bottom wall 28f of the brush retaining portion 28a through an upper opening portion of the spring receiving chamber 41. On the other hand, a linear-shaped another end portion 42c of each torsion coil spring 42 is inserted into (engaged with) the insertion groove 40, and thereby is elastically in contact with a rear end surface of the power-feeding brush 30a, 30b. Accordingly, each of the torsion coil springs 42 and 42 biases the power-feeding brush 30a, 30b toward the slip ring 26a, 26b. A tip side of the another end portion 42c is formed to be bent in a substantially L-shape. This L-shaped tip side of the another end portion 42c is elastically in contact with a substantially center of the axially rear end surface of the power-feeding brush 30a, 30b by a line contact.

As shown in FIG. 4A, when the retaining member 28 has not yet been attached to the cover member 3, i.e. is in a free state, a straight-line portion of the another end portion 42c of each torsion coil spring 42 is in contact with a bottom edge 40a of the insertion groove 40 so that the another end portion 42c is away from the power-feeding brush 30a, 30b by a slight clearance. Hence, each of the power-feeding brushes 30a and 30b is supported by the pigtail harness 33 without receiving a spring force, so that the power-feeding brushes 30a and 30b are prevented from dropping out of the brush guide portion 29a, 29b.

On the other hand, as shown in FIG. 4B, when the retaining member 28 is attached to the cover member 3 such that the tip surfaces 30c and 30d of the power-feeding brushes 30a and 30b move backwardly into the brush guide portions 29a and 29b against the spring force of the torsion coil springs 42 and 42 by abutting on the corresponding slip rings 26a and 26b, the another end portions 42c become elastically in contact with the rear end surfaces of the power-feeding brushes 30a and 30b so as to gradually increase the spring force. Thus, the power-feeding brushes 30a and 30b are biased toward the slip rings 26a and 26b.

As shown in FIG. 3, the pair of power-feeding terminal strips 31 and 31 extend in the upper-lower direction, and extend parallel to each other. Each of the pair of power-feeding terminal strips 31 and 31 is formed in a crank shape. One-side terminal (lower end portion) 31a of each of the power-feeding terminal strips 31 and 31 is exposed to a space whereas another-side terminal (upper end portion) 31b of each of the power-feeding terminal strips 31 and 31 protrudes in a female fitting groove 28d of the connector portion 28b

The one-side terminals 31a and 31a are arranged on and in contact with the upper surface of the bottom wall 28f. The one-side terminals 31a and 31a are connected with another end portions 33b and 33b of the pair of pigtail harnesses 33 and 33 by soldering.

As mentioned above, a length of each of the pigtail harnesses 33 and 33 is set to prevent the power-feeding brush 30a, 30b from dropping out of the brush guide portion 29a, 29b, when the another end portion 42c of the torsion coil spring 42 is in contact with the bottom edge 40a of the insertion groove 40 without applying the spring force to the power-feeding brush 30a, 30b (see FIG. 4A).

As shown in FIG. 1, an annular (ring-shaped) seal member 34 is fitted into and held by an annular fitting groove which is formed on an outer circumference of a base portion side of the brush retaining portion 28a. The annular seal member 34 becomes elastically in contact with a tip surface of the cylindrical wall 3b to seal an inside of the brush retaining portion 28a when the brush retaining portion 28a is inserted into the retaining hole 3c.

A male connector (not shown) is inserted into the fitting groove 28d which is located at an upper end portion of the connector portion 28b. The another-side terminals 31b and 31b which are exposed to the fitting groove 28d of the connector portion 28b are electrically connected through the male connector to a control unit (not shown).

As shown in FIG. 3, each of the pair of boss portions 28c is formed in a substantially triangular shape. Substantially at a center of each boss portion 28c, an annular metallic washer 53 is buried in and combined with the boss portion 28c. By attachment bolts (not shown) which pass through bolt insertion holes 53a formed at centers of the metallic washers 53, the retaining member 28 is attached to the cover main body 3a.

The motor output shaft 13 and the eccentric shaft portion 39 are rotatably supported by the small-diameter ball bearing 37 and the needle bearing 38. The small-diameter ball bearing 37 is provided on an outer circumferential surface of the shaft portion 10b of the cam bolt 10. The needle bearing 38 is provided on an outer circumferential surface of the cylindrical portion 9b of the follower member 9, and is located axially adjacent to the small-diameter ball bearing 37.

The needle bearing 38 includes a cylindrical retainer 38a and a plurality of needle rollers 38b. The retainer 38a is formed in a cylindrical shape (circular-tube shape), and is fitted in an inner circumferential surface of the eccentric shaft portion 39 by press fitting. Each needle roller 38b is a rolling element supported rotatably inside the retainer 38a. The needle rollers 38b roll on the outer circumferential surface of the cylindrical portion 9b of the follower member 9.

The inner race of the small-diameter ball bearing 37 is fixed between a front end edge of the cylindrical portion 9b of the follower member 9 and the head portion 10a of the cam bolt 10 in a sandwiched state. On the other hand, an outer race of the small-diameter ball bearing 37 is fixedly fitted in a stepped diameter-enlarged portion of the inner circumferential surface of the eccentric shaft portion 39 by press fitting. The outer race of the small-diameter ball bearing 37 is axially positioned by contacting a step edge (barrier) formed in the stepped diameter-enlarged portion of the inner circumferential surface of the eccentric shaft portion 39.

A small-diameter oil seal 46 is provided between the outer circumferential surface of the motor output shaft 13 (eccentric shaft portion 39) and an inner circumferential surface of the extending portion 5d of the motor housing 5. The oil seal 46 prevents lubricating oil from leaking from an inside of the speed-reduction mechanism 8 into the electric motor 12. The oil seal 46 separates the electric motor 12 from the speed-reduction mechanism 8 by a searing function of the oil seal 46.

The control unit detects a current operating state of the engine on the basis of information signals derived from various kinds of sensors and the like, such as a crank angle sensor, an air flow meter, a water temperature sensor and an accelerator opening sensor (not shown). Thereby, the control unit controls the engine. Moreover, the control unit performs a rotational control for the motor output shaft 13 by supplying electric power to the coils 18. Thereby, the control unit controls a relative rotational phase of the cam shaft 2 to the timing sprocket 1, through the speed-reduction mechanism 8.

As shown in FIGS. 1 and 5, the speed-reduction mechanism 8 is mainly constituted by the eccentric shaft portion 39, a medium-diameter ball bearing 47, the rollers 48, the retainer 36, and the follower member 9 formed integrally with the retainer 36. The eccentric shaft portion 39 conducts an eccentric rotational motion. The medium-diameter ball bearing 47 is provided on an outer circumference of the eccentric shaft portion 39. The rollers 48 are provided on an outer circumference of the medium-diameter ball bearing 47. The retainer 36 retains (guides) the rollers 48 along a rolling direction of the rollers 48, and permits a radial movement of each roller 48.

An outer circumferential surface of the eccentric shaft portion 39 includes a cam surface 39a. The cam surface 39a of the eccentric shaft portion 39 has a center (axis) Y which is eccentric (deviated) slightly from a shaft center X of the motor output shaft 13 in the radial direction.

Substantially whole of the medium-diameter ball bearing 47 overlaps with the needle bearing 38 in the radial direction. The medium-diameter ball bearing 47 includes an inner race 47a, an outer race 47b, and a ball(s) 47c interposed between both the races 47a and 47b. The inner race 47a is fixed to the outer circumferential surface of the eccentric shaft portion 39 by press fitting. The outer race 47b is not fixed in the axial direction, and thereby is in an axially freely-movable state. That is, one of axial end surfaces of the outer race 47b which is closer to the electric motor 12 is not in contact with any member whereas another of the axial end surfaces of the outer race 47b faces an inside surface of the retainer 36 to have a first clearance (minute clearance) C between the another of the axial end surfaces of the outer race 47b and the inside surface of the retainer 36. Moreover, an outer circumferential surface of the outer race 47b is in contact with an outer circumferential surface of each of the rollers 48 so as to allow the rolling motion of each roller 48. An annular second clearance C1 is formed on the outer circumferential surface of the outer race 47b. By virtue of the second clearance C1, whole of the medium-diameter ball bearing 47 can move in the radial direction in response to an eccentric rotation of the eccentric shaft portion 39, i.e., can perform an eccentric movement.

Each of the rollers 48 is formed of iron-based metal. With the eccentric movement of the medium-diameter ball bearing 47, the respective rollers 48 move in the radial direction and are fitted in the internal teeth 19a of the internal-teeth constituting portion 19. Also, with the eccentric movement of the medium-diameter ball bearing 47, the rollers 48 are forced to do a swinging motion in the radial direction while being guided in the circumferential direction by both side edges of the roller-retaining holes 36b of the retainer 36.

Lubricating oil is supplied into the speed-reduction mechanism 8 by a lubricating-oil supplying means. This lubricating-oil supplying means includes an oil supply passage, an oil supply hole 51, an oil hole 52 having a small hole diameter, and three oil discharge holes (not shown) each having a large hole diameter. The oil supply passage is formed inside the bearing 02 of the cylinder head 01. Lubricating oil is supplied from a main oil gallery (not shown) to the oil supply passage. The oil supply hole 51 is formed inside the cam shaft 2 to extend in the axial direction as shown in FIG. 1. The oil supply hole 51 communicates though a groove(s) with the oil supply passage. The oil hole 52 is formed inside the follower member 9 to pass through the follower member 9 in the axial direction. One end of the oil hole 52 is open to the oil supply hole 51, and another end of the oil hole 52 is open to a region near the needle bearing 38 and the medium-diameter ball bearing 47. The three oil discharge holes are formed inside the follower member 9 to pass through the follower member 9 in the same manner.

By the lubricating-oil supplying means, lubricating oil is supplied to the accommodating space 44 and held in the accommodating space 44. Thereby, the lubricating oil lubricates the medium-diameter ball bearing 47 and the rollers 48. Moreover, the lubricating oil flows to the inside of the eccentric shaft portion 39 and the inside of the motor output shaft 13 so that moving elements such as the needle bearing 38 and the small-diameter ball bearing 37 are lubricated. It is noted that the small-diameter oil seal 46 inhibits the lubricating oil held in the accommodating space 44 from leaking to the inside of the motor housing 5.

Next, operations in this embodiment according to the present invention will now be explained. At first, when the crankshaft of the engine is drivingly rotated, the timing sprocket 1 is rotated through the timing chain 42. This rotative force is transmitted through the internal-teeth constituting portion 19 and the female-thread constituting portion 6 to the motor housing 5. Thereby, the motor housing 5 rotates in synchronization. On the other hand, the rotative force of the internal-teeth constituting portion 19 is transmitted through the rollers 48, the retainer 36 and the follower member 9 to the cam shaft 2. Thereby, the cam of the cam shaft 2 opens and closes the intake valve.

Under a predetermined engine-operating state after the start of the engine, the control unit supplies electric power to the coils 18 of the electric motor 12 through the terminal strips 31 and 31, the pigtail harnesses 33 and 33, the power-feeding brushes 30a and 30b and the slip rings 26a and 26b and the like. Thereby, the rotation of the motor output shaft 13 is driven. This rotative force of the motor output shaft 13 is transmitted through the speed-reduction mechanism 8 to the cam shaft 2 so that a reduced rotation is transmitted to the cam shaft 2.

That is, the eccentric shaft portion 39 eccentrically rotates in accordance with the rotation of the motor output shaft 13. Thereby, each roller 48 rides over disengaged from) one internal tooth 19a of the internal-teeth constituting portion 19 and moves to the other adjacent internal tooth 19a with its rolling motion while being radially guided by the roller-retaining holes 36b of the retainer 36, every one rotation of the motor output shaft 13. By repeating this motion sequentially, each roller 48 rolls in the circumferential direction under a contact state. By this contact rolling motion of each roller 48, the rotative force is transmitted to the follower member 9 while the rotational speed of the motor output shaft 13 is reduced. A speed reduction rate which is obtained at this time can be set at any value by adjusting the number of rollers 48 and the like.

Accordingly the cam shaft 2 rotates in the forward or reverse direction relative to the timing sprocket 1 so that the relative rotational phase between the cam shaft 2 and the timing sprocket 1 is changed. Thereby, opening and closing timings of the intake valve are controllably changed to its advance or retard side.

A maximum postional restriction (angular position limitation) for the forward/reverse relative rotation of cam shaft 2 to the timing sprocket 1 is performed when one of respective lateral surfaces (circumferentially-opposed surfaces) of the stopper convex portion 61d becomes in contact with the corresponding one of the circumferentially-opposed surfaces 2c and 2d of the stopper concave groove 2b.

As a result, the opening and closing timings of the intake valve can be changed to the advance side or the retard side up to its maximum. Therefore, a fuel economy and an output performance of the engine are improved.

In this embodiment, the torsion coil springs 42 and 42 which bias the power-feeding brushes 30a and 30b toward the slip rings 26a and 26b are provided through the spring receiving chambers 41 and 41 in parallel with (side by side with) the power-feeding brushes 30a and 30b, but not in series with the power-feeding brushes 30a and 30b with respect to the axial direction of the valve timing control device. Hence, an axial length of the brush retaining portion 28a (i.e. a length in a width direction of the brush retaining portion 28a) can be effectively shortened.

That is, each of the coil springs 42 and 42 is provided to overlap with the power-feeding brush 30a, 30b with respect to the axial direction. Accordingly, whole of the valve timing control device has a shortened axial length, so that the valve timing control device can be downsized. As a result, an engine room can have a small accommodation space for an internal combustion engine equipped with the valve timing control device.

In particular, each of the torsion coil springs 42 and 42 is accommodated inside the spring receiving chamber 41 by the support shaft 45. Hence, the torsion coil springs 42 and 42 do not protrude from the bottom wall 28f of the brush retaining portion 28a. Because substantially whole of each torsion coil spring 42 is accommodated in the spring receiving chamber 41, the length of the brush retaining portion 28a in the width direction of the brush retaining portion 28a can be effectively shortened.

### Second Embodiment

FIGS. 8 to 10 show a second embodiment according to the present invention. A basic structure of the second embodiment is the same as that of the first embodiment. As different points, a location at which each insertion groove 40 is formed and a shape of the another end portion 42c of each torsion coil spring 42 are modified.

That is, each of the insertion grooves 40 is formed along the axial direction, substantially at a center of the wall of longer side of the rectangular brush guide portion 29a, 29b. On the other hand, the another end portion 40c of each torsion coil spring 40 has a tip portion bent in an L-shape. This tip portion is further curved in a convex curve shape. A convex top part of this convex curve portion 42d is in contact with one end surface of the power-feeding brush 30a, 30b.

The other configurations are the same as those of the first embodiment. Because each of the torsion coil springs 42 is provided in parallel with (side by side with) the power-feeding brush 30a, 30b, an axial length of the valve timing control device can be shortened. In addition, because the another end portion 40c of the torsion coil spring 40 has the tip portion formed as the convex curve portion 42d, the another end portion 40c of the torsion coil spring 40 can be in contact with the one end surface of the power-feeding brush 30a, 30b by a point contact or in a state closer to the point contact than a line contact. Therefore, a contact surface pressure becomes large so that the elastic contact of the another end portion 40c can be attained stably and reliably.

### Third Embodiment

FIGS. 11 to 12 show a third embodiment according to the present invention. In the third embodiment, the pigtail harness is not provided. Each of the torsion coil springs 42 and 42 is formed of electrical conductive material. The one end portion 42b of each of the torsion coil springs 42 and 42 is in contact with the one-side terminal 31a of the terminal strip 31. Moreover, a condenser 55, 55 is provided between the one-side terminal 31a, 31a and the metallic washer 53, 53 to connect the one-side terminal 31a, 31a with the metallic washer 53, 53.

Specifically, as shown in FIG. 11, each of the spring receiving chambers 41 and 41 is formed in a substantially L-shape as a planer view. As shown in FIG. 11, the lower-side spring receiving chamber 41 and the upper-side spring receiving chamber 41 are provided substantially at locations diagonally symmetrical to each other.

The one-side terminal 31a of each of the terminal strips 31 and 31 is bent in an L-shape. This L-shaped one-side terminals 31a and 31a are arranged to get away from each other in a bifurcated shape such that the one-side terminals 31a and 31a get respectively close to the metallic washers 53 and 53 of the boss portions 28c and 28c.

Each of the torsion coil springs 42 and 42 is made of alloy steel which contains, for example, copper as a conductive material. The center portion 42a of each of the torsion coil springs 42 and 42 is held and accommodated in the spring receiving chamber 41 via the support shaft 45. The one end portion 42b of each of the torsion coil springs 42 and 42 is elastically in contact with an upper surface of the one-side terminal 31a. The another end portion 42c of each of the torsion coil springs 42 and 42 is elastically in contact with one end surface of the power-feeding brush 30a, 30b. Each of the torsion coil springs 42 and 42 functions as a so-called inductor.

One lead wire 55a, 55a of each of the condensers 55 and 55 is connected with the upper surface of the one-side terminal 31a, 31a by soldering or the like, whereas another lead wire 55b, 55b of each of the condensers 55 and 55 is connected with an outer circumferential surface of the metallic washer 53, 53 by soldering or the like. It is noted that each of the metallic washers 53 and 53 is made of electrical conductive material, and an electrical continuity between the cover member 3 and one end surface of the metallic washer 53, 53 is established for grounding.

Moreover, as shown in FIGS. 12A and 12B, each of the brush guide portions 29a and 29b includes a stopper portion 29c, 29c formed by bending a lower end portion of the brush guide portion 29a in an inner direction thereof (in a horizontal direction of FIGS. 12A and 12B). On the other hand, each of the power-feeding brushes 30a and 30b includes a tip portion which is formed in a small-diameter shape given by a step. This step portion 30e, 30e is caught or stopped by the stopper portion 29c, 29c such that a maximum forward movement of the power-feeding brush 30a, 30b is restricted. Accordingly, as shown in FIG. 12A, the power-feeding brush 30a, 30b is prevented from dropping due to no pigtail harness when the power-feeding brush 30a, 30b is in a free state before assembly.

When the power-feeding brush 30a 30b is in the free state before assembly, the another end portion 42c of each torsion coil spring 42 is in contact with the bottom edge 40a of the insertion groove 40 so that a further elastic deformation of the torsion coil spring 42 is stopped. That is, the another end portion 42c is not in contact with the one end surface of the power-feeding brush 30a, 30b and keeps a slight clearance from the power-feeding brush 30a, 30b. However, after the assembly, as shown in FIG. 12A, the tip surface of the power-feeding brush 30a, 30b is in contact with the slip ring 26a, 26b, and thereby the power-feeding brush 30a, 30b has moved backwardly against the spring force of the torsion coil spring 42. Hence, the another end portion 42c is always in elastic contact with the one end surface of the power-feeding brush 30a, 30b.

The other configurations of the third embodiment are the same as those of the first embodiment. Hence operations and effects similar to the first embodiment are obtainable' in the third embodiment. Especially in the third embodiment the power-feeding brush 30a, 30b is electrically connected through the torsion coil spring 42 to the condenser 55. Therefore, an electromagnetic noise which is produced at the time of actuation of the electric motor 12 can be reduced effectively.

That is, when the control unit applies electric power to the electromagnetic coils 18 of the electric motor 12 and thereby actuates the electric motor 12, an electromagnetic noise is produced due to a rotation switching between the switching brush 25a, 25b and the commutator 21. Moreover, a separation between the power-feeding brush 30a, 30b and the slip ring 26a, 26b due to an abnormal engine vibration produces the electromagnetic noise.

Therefore, in this embodiment, the condenser 55, 55 is provided in the meddle of electric pathway so as to reduce the electromagnetic noise. Because it is conceivable that the electromagnetic noise is produced especially at the above-mentioned two spots, the condenser 55, 55 is located near the control unit (not shown) beyond the power-feeding brush 30a, 30b. That is, if the condenser 55 or an inductor is provided at a location far away from a generation source of the electromagnetic noise, the noise is radiated on the electric pathway so that the provision of the condenser 55 or the inductor is rendered in vain. Therefore, in this embodiment, the condenser 55, 55 is arranged near the generation source of the electromagnetic noise.

Accordingly, the electromagnetic noise is introduced from the power-feeding brush 30a, 30b through the torsion coil spring 42, 42 (functioning as an inductor) to the one-side terminal 31a, 31a. Then, the electromagnetic noise flows from the one-side terminal 31a, 31a through the condenser 55, 55, the metallic washer 53, 53 and the cover member 3 to a ground earth of the internal combustion engine. Hence, the electromagnetic noise can be reduced effectively.

Generally, two electronic components of condenser and inductor have to be provided in order to reduce the electromagnetic noise. In such a case, the number of components is increased so that a cost is increased by necessity.

Therefore, in this embodiment, the torsion coil spring 42 is used as the inductor. Hence, the cost can be reduced with a reduction of the number of components.

The present invention is not limited to the above embodiments. For example, a biasing member that biases the power-feeding brush 30a, 30b is not limited to the torsion coil spring 42. As this biasing member, a leaf spring or the like which is able to be provided in parallel with the power-feeding brush may be used.

Moreover, the support shaft 45 may be made of electrical conductive material to be used as the inductor.

1. A valve timing control device for an internal combustion engine, comprising:
a drive rotating member configured to receive rotational force from a crankshaft;
a driven rotating member fixed to a cam shaft configured to receive rotational force from the drive rotating member;
an electric motor including a motor housing configured to rotate together with the drive rotating member or the driven rotating member, the electric motor being configured to rotate the drive rotating member relative to the driven rotating member by a supplied electric current;
a power-feeding brush provided outside of the electric motor and configured to supply electric power to the electric motor;
a slip ring provided on one of the drive rotating member and the driven rotating member and configured to slide in contact with the power-feeding brush; and
a torsion coil spring biasing the power-feeding brush toward the slip ring, wherein the torsion coil spring is arranged lateral to the power-feeding brush such that the torsion coil spring is in parallel with the power-feeding brush.

2. The valve timing control device according to claim 1, wherein
the torsion coil spring is made of an electrical conductive material,
the torsion coil spring includes a linear end portion which is constantly in elastic contact with an axial one end surface of the power-feeding brush to supply electric power to the power-feeding brush, and
a condenser is electrically connected to the torsion coil spring.

3. The valve timing control device according to claim 2, wherein
the linear end portion of the torsion coil spring includes a tip side curved in a convex shape, and
a convex-shaped curve portion of the tip side is in elastic contact with the one end surface of the power-feeding brush by a point contact.

4. The valve timing control device according to claim 3, wherein
the power-feeding brush is held in a brush guide portion of a brush retaining portion of a retaining member such that the power-feeding brush is movable toward the slip ring, and
an insertion groove into which the linear end portion of the torsion coil spring is inserted in an axial direction is formed in one end edge of the brush guide portion.

5. The valve timing control device according to claim 4, wherein the insertion groove is in a slit shape extending in the axial direction of the brush guide portion.

6. The valve timing control device according to claim 5, wherein
each of the power-feeding brush and the brush guide portion is in a substantially rectangular shape in cross section, and
the insertion groove is formed in a sidewall of the brush guide portion.

7. The valve timing control device according to claim 5, wherein each of the power-feeding brush and the brush guide portion is in a substantially rectangular shape in cross section, and
the insertion groove is formed in a sidewall of longer side of the brush guide portion.

8. The valve timing control device according to claim 4, wherein
the linear end portion of the torsion coil spring is stopped by a bottom edge of the insertion groove so as not to bias the power-feeding brush any more, when the power-feeding brush is in a free state before becoming in elastic contact with the slip ring.

9. The valve timing control device according to claim 2, wherein
the torsion coil spring contains a conductive alloy material of Corson alloy or beryllium copper.

10. The valve timing control device according to claim 2, wherein
the power-feeding brush is included in positive-side and negative-side power-feeding brushes,
the torsion coil spring is included in two torsion coil springs, and
the two torsion coil springs are arranged along the positive-side and negative-side power-feeding brushes or arranged diagonally symmetrical to each other, through spring receiving chambers.

11. The valve timing control device according to claim 2, wherein
the electric motor includes a permanent magnet at an inner circumferential portion of the motor housing, as a stator,
the permanent magnet is configured to rotate with the drive rotating member, and
the electric motor is configured to transmit rotational force of a rotor of the electric motor relative to the permanent magnet, through a speed-reduction mechanism to the driven rotating member.

12. The valve timing control device according to claim 11, wherein
the electric motor is a DC motor in which a coil is wound on the rotor.

13. The valve timing control device according to claim 12, wherein
the power-feeding brush is held in a brush guide portion of a retaining member such that the power-feeding brush is movable toward the slip ring, and
the retaining member is attached to a cover member fixed to a cylinder head of the internal combustion engine.

14. The valve timing control device according to claim 13, wherein
the cover member is made of an aluminum alloy material.

15. The valve timing control device according to claim 14, wherein
the retaining member and a connector portion formed integrally with the retaining member are made of a synthetic resin material.

16. A valve timing control device for an internal combustion engine, comprising:
a drive rotating member configured to receive rotational force from a crankshaft;
a driven rotating member fixed to a cam shaft configured to receive rotational force from the drive rotating member;
an electric motor including a motor housing configured to rotate together with the drive rotating member or the driven rotating member, the electric motor being configured to rotate the drive rotating member relative to the driven rotating member by a supplied electric current;
a power-feeding brush provided outside of the electric motor and configured to supply electric power to the electric motor;
a slip ring provided on one of the drive rotating member and the driven rotating member and configured to slide in contact with the power-feeding brush; and
a torsion coil spring biasing the power-feeding brush toward the slip ring, wherein at least a part of the torsion coil spring overlaps with the power-feeding brush with respect to an axial direction.

17. The valve timing control device according to claim 16, wherein
the torsion coil spring is made of an electrical conductive material,
the torsion coil spring includes a linear end portion which is constantly in elastic contact with an axial one end surface of the power-feeding brush to supply electric power to the power-feeding brush, and
a condenser is electrically connected to the torsion coil spring.
